(19) United States
(12) Patent Application Publication
(10) Pub. No.: US 2018/0038983 A1
(43) Pub. Date: Feb. 8, 2018

(54) EARTH SURVEYING WITH AERIAL DRONES FOR IMPROVED DRILLING APPLICATIONS

(71) Applicant: Liquid Robotics Oil and Gas LLC, Houston, TX (US)

(72) Inventors: Sudhir Pai, Houston, TX (US); Benny Poedjono, Sugar Land, TX (US); Graham Lancaster Hine, Los Gatos, CA (US)

(21) Appl. No.: 15/788,242

(22) Filed: Oct. 19, 2017

Related U.S. Application Data
(63) Continuation-in-part of application No. 15/431,471, filed on Feb. 13, 2017, now abandoned.
Application No. 15/431,471 is a continuation of application No. 15/073,186, filed on Mar. 17, 2016, now Pat. No. 9,588,248.
Application No. 15/073,186 is a continuation of application No. 14/024,935, filed on Sep. 12, 2013, now Pat. No. 9,316,758.
(60) Provisional application No. 61/828,584, filed on May 29, 2013.

(51) Int. Cl. G01V 3/165; G01V 3/26

(52) U.S. Cl. CPC G01V 3/165; G01V 3/26

(57) ABSTRACT

Methods and apparatuses for geophysical surveying are disclosed. In one embodiment, an airborne vehicle may obtain magnetic measurements in a location around a drilling site. The magnetic measurements may be used to calculate a localized disturbance magnetic field resulting from, for example, solar flares. The localized disturbance magnetic field may be used to calculate a declination value and, thus, a wellbore position with improved accuracy.

### CROSS-REFERENCE TO RELATED APPLICATIONS

This application is a continuation-in-part of U.S. patent application Ser. No. 15/431,471 filed Feb. 13, 2017 and entitled “EARTH SURVEYING FOR IMPROVED DRILLING APPLICATIONS,” which is a continuation of U.S. patent application Ser. No. 15/073,186 filed Mar. 17, 2016 and entitled “EARTH SURVEYING FOR IMPROVED DRILLING APPLICATIONS,” now issued as U.S. Pat. No. 9,588,248, which is a continuation of U.S. patent application Ser. No. 14/024,935 filed Sep. 12, 2013 and entitled “EARTH SURVEYING FOR IMPROVED DRILLING APPLICATIONS,” now issued as U.S. Pat. No. 9,316,758, which claims benefit of priority to U.S. Provisional Application No. 61/828,584 filed May 29, 2013 and entitled “EARTH SURVEYING FOR IMPROVED DRILLING APPLICATIONS,” all of which are hereby incorporated by reference in their entirety.

### BACKGROUND

Wellbore position accuracy ensures successful drilling at a drilling site to a geological target, such as an underground reservoir of fluids including oil. Magnetic surveying of the area near the drilling site may improve an operator's ability to safely reach the geological target. One conventional technique is to use a model of Earth's magnetic field to calculate wellbore position. For example, the International Geomagnetic Reference Field (IGRF) has been used as magnetic models. However, these magnetic models are not accurate enough to provide detailed magnetic information for a particular localized area near a drilling site. For example, in the presence of solar activity, these geomagnetic models are unable to provide accurate localized magnetic field values around the world.

### SUMMARY

In some embodiments, localized magnetic field measurements may be obtained near a drilling site, or other location, from a marine vehicle configured with a magnetic measurement device. In some embodiments, the marine vehicle may be a small, automated, unmanned robot with towed or hull-mounted sensors, including magnetic measurement devices. In some embodiments an airborne vehicle, such as a drone, may be used in place of or in addition to the marine vehicle. In one embodiment, the magnetic measurement device is attached to a tow wire and towed behind the marine vehicle. In another embodiment, the magnetic measurement device is contained in a payload of the airborne vehicle. The marine vehicle and/or the airborne vehicle may be programmed with a grid pattern to measure near a drilling site. When tracing the grid pattern, the marine vehicle and/or the airborne vehicle may transmit magnetic measurements to another location, such as a magnetic observatory. In some embodiments, the magnetic measurements may be obtained in real-time (or near-real time) and utilized in modeling with a network of magnetic observatories and forward surface measurement to extend the range from one magnetic observatory, such as the nearest observatory or observatories, to the area of interest.

In one embodiment, a method may include receiving a magnetic field for a location from a vehicle at the location. The method may also include calculating a localized magnetic disturbance based, at least in part, on the received magnetic field. The method may further include calculating a wellbore position based, at least in part, on the calculated localized magnetic disturbance.

In another embodiment, an apparatus may include a marine vehicle. Alternatively or additionally, the apparatus may include an airborne vehicle. The apparatus may also include a magnetic measurement device attached to the marine vehicle and/or to the airborne vehicle. The apparatus may further include a processing system attached to the marine vehicle and/or the airborne vehicle, the processing system configured to receive magnetic measurements from the magnetic measurement device and to transmit the magnetic measurements to a magnetic observatory.

In a further embodiment, a system may include a network of magnetic observatories. The system may also include at least one marine vehicle having a magnetic measurement device. Alternatively or additionally, the system may include at least one airborne vehicle having a magnetic measurement device. The system may further include a processing station configured to receive magnetic measurements from the network of magnetic observatories and the at least one marine and/or airborne vehicle. The processing system may include a memory for storing the received magnetic measurements and a processor coupled to the memory. The processor may be configured to perform the steps of processing the received magnetic measurements and calculating a localized disturbance field in an area local to a magnetic measurement obtained by the at least one marine and/or airborne vehicle.

The foregoing has outlined rather broadly certain features and technical advantages of some embodiments of the disclosure in order that the detailed description that follows may be better understood. Additional features and advantages will be described hereinafter that form the subject of the claims. It should be appreciated by those having ordinary skill in the art that the specific embodiments disclosed may be readily utilized as a basis for modifying or designing other structures for carrying out the same or similar purposes. It should also be realized that such equivalent constructions do not depart from the spirit and scope of the invention as set forth in the appended claims. The novel features that are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the disclosure.

### BRIEF DESCRIPTION OF THE DRAWINGS

For a more complete understanding of the disclosed system and methods, reference is now made to the following descriptions taken in conjunction with the accompanying drawings.

FIG. 1 is a perspective view of a marine vehicle with a towed magnetic measurement device according to one embodiment of the disclosure.

FIG. 2 is a map illustrating a system of magnetic observatories and marine or airborne vehicles for supporting a drilling site according to one embodiment of the disclosure.

FIG. 3 is a flow chart illustrating a method of calculating a wellbore position according to one embodiment of the disclosure.

FIG. 4A is a perspective view of an airborne vehicle with a magnetic measurement device payload according to one embodiment of the disclosure.

FIG. 4B is a perspective view of an airborne vehicle with a magnetic measurement device payload according to one embodiment of the disclosure.

### DETAILED DESCRIPTION

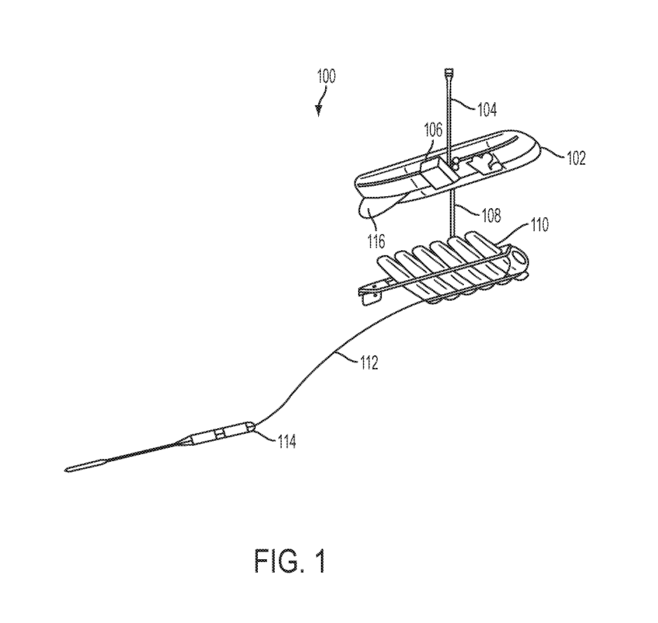

FIG. 1 is a perspective view of a marine vehicle with a towed magnetic measurement device according to one embodiment of the disclosure. A marine vehicle 100 may include a hull 102, a mast assembly 104, and a payload section 106. The payload section 106 may include, for example, a processing system coupled to an antenna on the mast assembly 104. A sub 110 may be attached to the hull 102 by an umbilical cord 108. The umbilical cord 108 may include cables to facilitate power transmission and communications between the processing system in the payload section 106 with electronic devices on the sub 110. A magnetic measurement device 114, such as a magnetometer, may be attached to the sub 110 by a tow wire 112. The magnetic measurement device 114 may also be directly attached to the hull 102 by a tow wire or mounted to the hull 102. The magnetic measurement device 114 may include magnetometers for scientific seaborne applications, bi-axial horizontal and/or vertical magnetometer systems, and/or automated true-north tri-axial magnetometer systems. The tow wire 112 may likewise facilitate power transmission and communications between the processing system in the payload section 106 and the magnetic measurement device 114. The marine vehicle 100 may have a magnetic signature that has a negligible effect on magnetic measurements obtained by the magnetic measurement device 114. In one embodiment, the marine vehicle 100 may be constructed entirely of non-magnetic materials.

The hull 102 may include solar panels (not shown) for generating power and a battery (not shown) in the payload section 106 for storing power from the solar panels, to allow twenty-four hour operation of the marine vehicle 100. The solar panels and battery may be configured to keep the marine vehicle 100 in operation for approximately two to three weeks, or longer. Alternatively, or additionally, the hull 102 may include or be coupled to a wave power generation apparatus (not shown) for generating power using waves and/or current around the marine vehicle 100. The hull 102 may also include a wind power generation apparatus (not pictured), such as one or more turbines, for generating power using wind around the marine vehicle 100.

A rudder 116 on the hull 102 may be controlled by the processing system to navigate the marine vehicle 100 near a drilling site for obtaining magnetic measurements of a localized magnetic disturbance field. For example, the processing system may control the rudder 116 to navigate the marine vehicle 100 in a grid search pattern around the drilling site. In another example, the processing system may receive commands from a remote location, such as the drilling site or magnetic observatory, instructing the marine vehicle to proceed to a particular destination and control the rudder 116 appropriately. The payload section 106 may be fitted with a global positioning system (GPS) receiver to provide accurate or improved location information to the processing system.

The processing system may obtain magnetic field measurements from the magnetic measurement device 114 and store or transmit the magnetic field measurements. The magnetic field measurements may be tagged with location information from the GPS receiver. If the measurements are stored by the processing system, the marine vehicle 100 may later be retrieved and the data downloaded from a memory of the processing system. If the measurements are transmitted, the processing system may include a wireless transmitter configured to transmit the magnetic measurements to a remote location, such as to a nearby magnetic observatory or the drilling site.

The payload section 106 may also be loaded with additional sensor devices to provide a suite of one or more services including, but not limited to, metrological, oceanographic, bathymetric, deep water data harvesting from subsea structures and seabeds, hydrocarbon seep mapping, turbidity measurements, marine mammal monitoring, source signature processing and water column profiling. In some embodiments, magnetic surveying may be performed in combination with a geophysical survey.

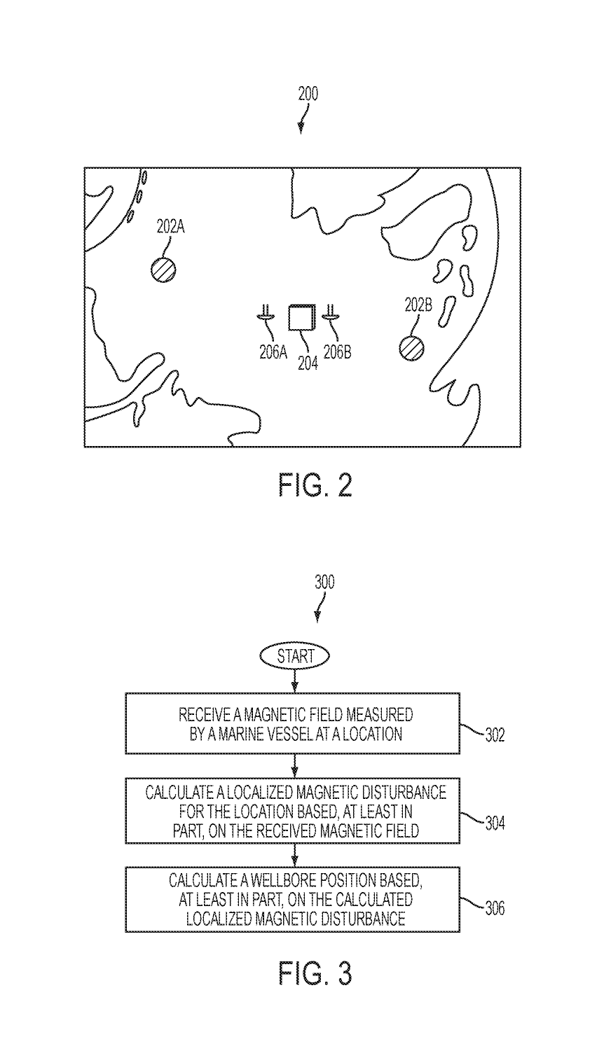

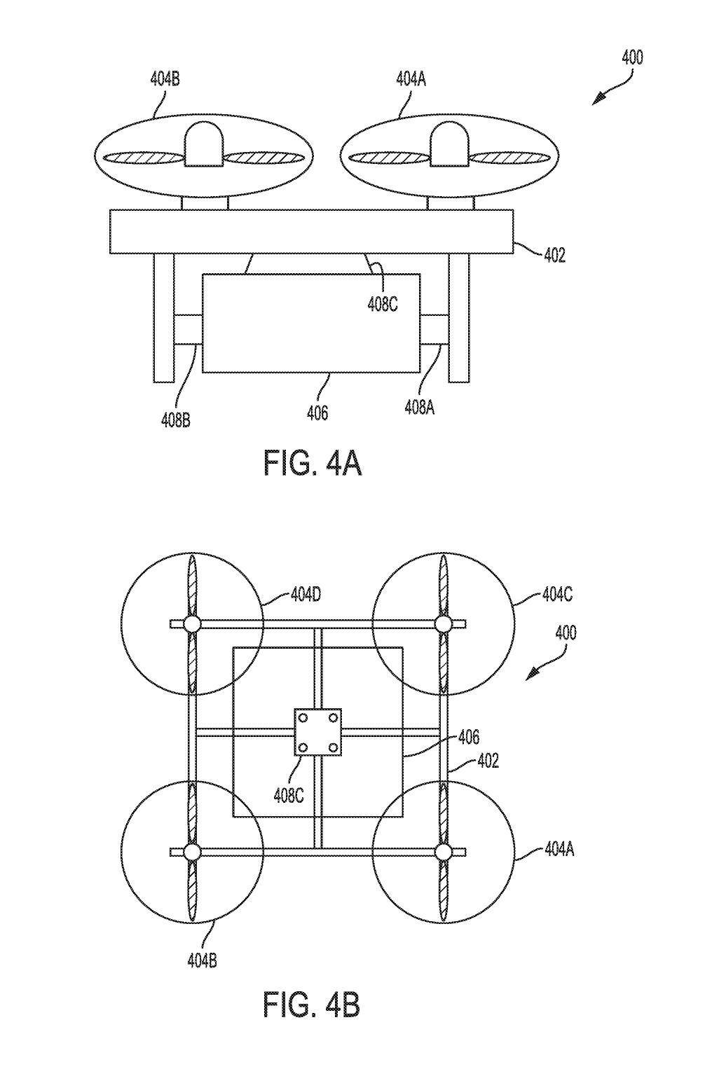

The marine vehicle of FIG. 1 may be implemented in a system for measuring magnetic fields near a drilling site. Alternatively or additionally, the airborne vehicle of FIGS. 4A-B may be implemented in a system for measuring magnetic fields near a drilling site. FIG. 2 is a map illustrating a system of magnetic observatories and marine and/or airborne vehicles for supporting a drilling site according to one embodiment of the disclosure. A system 200 may include a network of magnetic observatories 202A, 202B near a drilling site 204. A fleet of vehicles 206A, 206B may also be deployed near the drilling site 204. The vehicles 206A, 206B may be marine vehicles or airborne vehicles. Alternatively, the fleet may consist of a combination of both marine vehicles and airborne vehicles. The magnetic observatories 202A may obtain general magnetic measurements for the area near the drilling site 204, such as by consulting magnetic models and/or other data available. The vehicles 206A, 206B may be deployed near the drilling site 204 to obtain localized magnetic measurements near the drilling site 204 to improve the accuracy of calculated magnetic fields at the drilling site 204, and consequently to improve the accuracy of wellbore positioning at the drilling site 204. Alternatively or additionally, airborne and/or marine vehicles may be implemented similarly in a system for conducting pre-site surveys near, or far from, an existing drilling site. Pre-site surveys may involve control by operators to determine, based on magnetic field measurement, locations for exploration and/or drilling.

The vehicles 206A, 206B may transmit magnetic measurements to a processing station at the magnetic observatories 202A, 202B, or to another facility, such as a processing system at the drilling site 204. When the magnetic measurements are received, the wellbore position may be re-calculated and operations at the drilling site 204 adjusted based on the new calculation. One method utilizing the localized magnetic measurements is described with reference to FIG. 3 below.

FIG. 3 is a flow chart illustrating a method of calculating a wellbore position according to one embodiment of the disclosure. A method 300 begins at block 302 with receiving a magnetic field measured by a marine vehicle at a location, such as a location near a drilling site or a potential wellbore. Alternatively, the received magnetic field may be measured by an airborne vehicle at the location. According to one embodiment, a marine or airborne vehicle, such as that of FIG. 1 or FIGS. 4A-B, may acquire data in one second intervals utilizing GPS triggers and transmit them to a processing station at one minute intervals. The magnetic measurements received by the processing station may be made available for remote viewing or access, which in some embodiments may be through a web interface.

At block 304, a localized magnetic disturbance for the location is calculated based, at least in part, on the received magnetic field measurements of block 302. A total magnetic field (TMI), which is measured by the marine vessel at the location, may include three components, a main field, B_{M}, a crustal field, B_{C}, and a local disturbance field, B_{D}. The main field, B_{M}, and the crustal field, B_{C}, may be modeled for the location or be derived from the continuous monitoring at the location by fitting the spline with knot separations, where the spline is the sum of the B_{M} and B_{C}. Thus, the difference between the measured magnetic field at the location and the sum of the main field, B_{M}, and the crustal field, B_{C}, is the local disturbance field, B_{D}. The disturbance field, B_{D}, may be the result of, for example, solar flares that alter the Earth's magnetic fields.

At block 306, a wellbore position may be calculated based, at least in part, on the calculated localized magnetic disturbance field, B_{D}, of block 304. For example, the total magnetic field (TMI), which includes the calculated localized magnetic disturbance field, B_{D}, may be used to calculate a declination value, which is the difference between magnetic north and true north. The declination value may be used by operators of a drilling site to direct the drilling operations to reach the underground reservoir.

The use of a marine or airborne vehicle for obtaining localized magnetic measurements near a drilling site or other location may reduce the risk and high fixed-asset investment in obtaining determining wellbore positions. The marine or airborne vehicle may operate unmanned in locations hostile to human life or difficult for humans to access. For example, the unmanned marine or airborne vehicle reduces or eliminates crew exposure to piracy or need for search and rescue (SAR) assets, when compared to traditional seaborne or airborne magnetic acquisition operations.

The method described with reference to FIG. 3 may be carried out by a processing station, located at the drilling site, the magnetic observatory, or another location; or via distributed computing systems situated at multiple locations. The processing station may include a memory for storing received magnetic measurements and other data and may include a processor coupled to the memory for executing the processing of the received magnetic measurements.

FIGS. 4A-B are perspective views of an example airborne vehicle 400 with a payload 406 containing a magnetic measurement device according to one embodiment of the disclosure. An airborne vehicle 400, such as a drone, may include a frame 402, one or more propellers 404A-D, a payload 406, and one or more attachment mechanisms 408A-C, such as screws, welding, clips, and other attachment mechanisms, for attaching the payload 406 to the frame 402. The payload 406 may include, for example, a processing system coupled to an antenna on the frame 402 or within the payload 406. The antenna may, for example, be integrated into the frame 402. A magnetic measurement device (not shown), such as a magnetometer, may be included in the payload 406. The magnetic measurement device may also be integrated into a frame 402 of the airborne vehicle 400. The magnetic measurement device may include magnetometers for scientific seaborne applications, bi-axial horizontal and/or vertical magnetometer systems, and/or automated true-north tri-axial magnetometer systems. The airborne vehicle 400 may have a magnetic signature that has a negligible effect on magnetic measurements obtained by the magnetic measurement device. In one embodiment, the airborne vehicle 400 may be constructed entirely of non-magnetic materials.

Solar panels (not shown) may be attached to or integrated into the frame 402 for generating power, and a battery (not shown) may be included in the payload 406 for storing power from the solar panels, to allow twenty-four hour operation of the airborne vehicle 400. The solar panels and battery may be configured to keep the airborne vehicle 400 in operation for approximately two to three weeks, or longer. Alternatively or additionally, the airborne vehicle 400 may include a reservoir (not shown) of a lighter-than-air gas, such as in a balloon, to provide lift and conserve energy. The frame 402 may also include a wind power generation apparatus (not pictured), such as one or more turbines, for generating power using wind around the airborne vehicle 400.

One or more propellers 404A-D on the frame 402 may be controlled by the processing system to provide lift and to navigate the airborne vehicle 100 near a drilling site for obtaining magnetic measurements of a localized magnetic disturbance field. The airborne vehicle 400 may be a drone, may operate autonomously, and/or may be controllable by a flight controller at a remote location. For example, the processing system may control the propellers 404A-D to navigate the airborne vehicle 400 in a grid search pattern around the drilling site. Multiple processing systems of multiple airborne vehicles may coordinate with one another to navigate the multiple airborne vehicles in a coordinated grid search pattern around the drilling site. For example, each airborne vehicle may coordinate through wireless communications with the other airborne vehicles to navigate a specific portion of the overall grid search pattern around the drilling site. In some embodiments, one or more marine vehicles may communicate with one or more airborne vehicles to provide additional data related to magnetic measurements of a localized magnetic disturbance field and other measurements. In another example, the processing system may receive commands through wireless communications from a remote location, such as the drilling site or magnetic observatory, instructing the airborne vehicle to proceed to a particular destination and control the propellers 404A-D appropriately. The payload 406 may be fitted with a global positioning system (GPS) receiver to provide accurate or improved location information to the processing system.

The processing system may obtain magnetic field measurements from the magnetic measurement device in the payload of the airborne vehicle 400 and store or transmit the magnetic field measurements. The magnetic field measurements may be tagged with location information from the GPS receiver. If the measurements are stored by the processing system, the airborne vehicle 400 may later be retrieved and the data downloaded from a memory of the processing system. If the measurements are transmitted, the processing system may include a wireless transmitter configured to transmit the magnetic measurements to a remote location, such as to a nearby magnetic observatory or the drilling site.

The payload section 406 may also be loaded with additional sensor devices to provide services including, but not limited to, metrological, oceanographic, bathymetric, deep water data harvesting from subsea structures and seabeds, hydrocarbon seep mapping, turbidity measurements, marine mammal monitoring, source signature processing and water column profiling. In some embodiments, magnetic surveying may be performed in combination with a geophysical survey.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain of its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. For example, features described relating to a marine vessel may be incorporated as features of an airborne vehicle, or other types of vehicles, and vice versa. Accordingly, the appended claims are intended to include within their scope such processes, machines, manufacture, compositions of matter, means, methods, or steps.

What is claimed is:

1. A method, comprising:
receiving a magnetic field measurement for a location from an airborne vehicle at the location, wherein the magnetic field corresponds to measurements below a surface level;
monitoring a magnetic field at the location to determine a crustal field at the location;
calculating a localized magnetic disturbance related to solar activity and independent of a main field and independent of the crustal field based, at least in part, on the received magnetic field measurement by subtracting the magnetic field measurement from the crustal field; and
calculating a wellbore position based, at least in part, on the calculated local magnetic disturbance.

2. The method of claim 1, further comprising receiving a plurality of measured magnetic field values of a plurality of locations arranged along a grid pattern.

3. The method of claim 1, in which the step of calculating a localized magnetic disturbance comprises:
calculating a main field; and
calculating the localized magnetic disturbance based on the main field and the crustal field.

4. The method of claim 1, further comprising calculating a declination based, at least in part, on the calculated localized magnetic disturbance.

5. The method of claim 1, wherein the step of receiving the magnetic field measurement comprises receiving the magnetic field measurement in real-time.

6. The method of claim 1, wherein the step of monitoring a magnetic field at the location to determine a crustal field at the location comprises monitoring the location by fitting a spline with knot separations, wherein the spline is the sum of a main field and the crustal field.

7. An apparatus, comprising:
an airborne vehicle;
a magnetic measurement device, the magnetic measurement device configured to obtain magnetic measurements below a surface level for drilling calculations, the magnetic measurement device attached to the airborne vehicle, and wherein the airborne vehicle is configured to monitor a magnetic field at a location;
a processing system attached to the airborne vehicle, the processing system configured to receive magnetic measurements from the magnetic measurement device, to determine a crustal field at the location, and to transmit the magnetic measurements to a magnetic observatory for calculating a wellbore position based, at least in part, on a calculated localized magnetic disturbance related to solar activity and independent of a main field and independent of the crustal field, wherein the calculated localized magnetic disturbance is calculated by subtracting a magnetic field measurement of the magnetic measurements from the determined crustal field.

8. The apparatus of claim 7, in which the magnetic measurement device is contained in a payload of the airborne vehicle.

9. The apparatus of claim 7, in which the airborne vehicle comprises a non-magnetic material.

10. The apparatus of claim 7, in which the airborne vehicle is a drone.

11. The apparatus of claim 7, further comprising at least one of a metrological, an oceanographic, and a bathymetric sensor.

12. The apparatus of claim 7, further comprising a guidance system configured to navigate the airborne vehicle through a grid pattern.

13. The apparatus of claim 7, in which the processing system is configured to transmit the magnetic measurements in real-time.

14. A system, comprising:
at least one airborne vehicle having a magnetic measurement device for obtaining magnetic measurements below a surface level for drilling calculations; and
a processing station configured to receive magnetic measurements from the at least one airborne vehicle, the processing station comprising:
a memory for storing the received magnetic measurements; and
a processor, in which the processor is configured to perform the steps of:
processing the received magnetic measurements;
determining a crustal field based on the received magnetic measurements;
calculating a localized magnetic disturbance field in an area local to a magnetic measurement related to solar activity and independent of a main field and independent of the crustal field by subtracting one of the received magnetic measurements from the determined crustal field; and
calculating a wellbore position based, at least in part, on the calculated localized magnetic disturbance field.

15. The system of claim 14, in which the magnetic measurement device is contained in a payload of the at least one airborne vehicle.

16. The system of claim 14, in which the at least one airborne vehicle further comprises a guidance system configured to navigate the airborne vehicle through a grid pattern.

17. The system of claim 14, in which the at least one airborne vehicle further comprises at least one of a metrological, an oceanographic, and a bathymetric sensor.

18. The system of claim 14, in which the at least one airborne vehicle is configured to transmit the magnetic measurements in real-time.

19. The system of claim 14, in which the processor is further configured to perform the steps of:
calculating a main field; and
calculating the localized magnetic disturbance based on the main field and the crustal field.

20. The system of claim 14, wherein the step of determining the crustal field comprises monitoring the location by fitting a spline with knot separations, wherein the spline is the sum of a main field and the crustal field.
